(19) United States
(12) Patent Application Publication
(10) Pub. No.: US 2008/0009278 A1
(43) Pub. Date: Jan. 10, 2008

(54) Method and apparatus for scanning access point of portable communication terminal

(75) Inventor: Joon-Young Jung, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/803,804

(22) Filed: May 16, 2007

(30) Foreign Application Priority Data
Jul. 10, 2006 (KR) 10-2006-0064204

(51) Int. Cl. H04Q 7/20; H04M 1/00

(52) U.S. Cl. 455/422.1; 455/550.1

(57) ABSTRACT

A method for scanning an Access Point (AP) of a portable communication terminal is provided, which includes upon camping onto an AP, storing current cell environment information to a memory, periodically scanning a cell, comparing the result of the scanning with the stored cell environment information of the memory, computing the number of cells within an acceptable error range, and conducting a scanning at a predefined scanning period according to the number of cells.

### PRIORITY

This application claims priority under 35 U.S.C. § 119 to an application filed in the Korean Intellectual Property Office on Jul. 10, 2006 and assigned Serial No. 2006-64204, the contents of which are incorporated herein by reference.

### BACKGROUND OF THE INVENTION

1. Field of the Invention

The present invention relates generally to a portable communication terminal, and more particularly, to a method and apparatus for scanning an Access Point (AP) in a portable terminal.

2. Description of the Related Art

The Unlicensed Mobile Access (UMA) is the next generation technology which converges wired and wireless communications and connects Global System for Mobile communication/General Packet Radio Service (GSM/GPRS) network with a wireless Local Area Network (LAN), using unlicensed spectrum such as the Bluetooth® (hereinafter “Bluetooth”) or I.E.E.E.802.11. A terminal incorporating the UMA technology is capable of voice and data communications, and use of wired and wireless communications.

FIG. 1 illustrates a conventional UMA Network.

Referring to FIG. 1, the UMA Network (UMAN) 120 includes an AP 107 and a UMA Network Controller (UNC) 109. The AP 107 acts as a Base Transceiver Station (BTS) 103 of the cellular network 110, and provides a radio link of the UMA terminal 101. The UNC 109 acts as a core network of the GSM/Enhanced Data rates for GSM Evolution (EDGE) Radio Access Network (GERAN) Base Station Subsystem (BSS) of the cellular network 110. The BSS includes the BTS 103 and the BSC 105. The UNC 109 also includes a Security GateWay (SGW) for secure communications with the UMA terminal 101, which is a dual-mode terminal that supports a multimedia network between the European mobile communication type GSM and the wireless LAN. The core of the Core Mobile Network (CMN) 130 is the Mobile Switching Center (MSC). The MSC is similar to the exchanger of the Public Switched Telephone Network (PSTN), and handles such functions as mobility management, location registration/management, authentication, handover and rove in/out.

One of the most important characteristics of the UMA terminal includes rove-in/out and handover support. Rove-in/out is the process in which a UMA terminal disposed within a wireless LAN accesses the UMA network to use GSM voice and GPRS data service, and a UMA terminal moving out of a wireless LAN accesses a cellular network to use it. The handover is the process in which a user of a UMA terminal continuously uses a voice call through a UMA network, when the UMA terminal is moved from a cellular network range to the wireless LAN range by using a GSM voice call.

Because a UMA terminal supports both the rove-in/out and handover, a user of the UMA terminal wants to use the entire service of the GSM, upon entering into the UMA network. Accordingly, a UMA terminal, which receives a service in a GSM network, that is, a UMA terminal receiving a service in a cellular network continuously determines whether it is within the coverage of wireless LAN, by a periodical AP scanning. More specifically, the UMA terminal conducts I.E.E.E. 802.11 coverage scan to locate an AP. The period of scanning varies, depending on the power conservation policy of the terminal. For example, a UMA terminal may wake up every 10 seconds, and conduct a scanning in the range below 100 ms.

The efficiency of rove-in/out and handover can be increased by shortening the AP scanning period, because a terminal within a wireless LAN area can rapidly detect an AP and use the UMA network. However, frequent AP scanning will cause increased power consumption and reduced battery life.

The power consumption may be reduced by extending the AP scanning period, but a terminal within the wireless LAN cannot rapidly detect the AP. In other words, even when a user of the terminal enters the area covered by the AP, the user may not use the service instantly, because it takes time for the automatic camp-on, rove-in/out and handover of the AP. This results in an inconvenience to the user.

### SUMMARY OF THE INVENTION

An aspect of the present invention is to substantially solve at least the above problems and/or disadvantages and to provide at least the advantages below. Accordingly, an aspect of the present invention is to provide a method and apparatus for scanning an AP of a portable communication terminal.

Another aspect of the present invention is to provide a method and apparatus for conducting an AP scanning of a portable communication terminal, which stores information about cell environment including a certain AP, and which shortens the AP scanning period if the environment has a high similarity to the stored cell environment.

An aspect of the present invention provides a method and apparatus for scanning an AP of a portable communication terminal, which includes, upon camping onto an AP, storing current cell environment information to a memory, periodically scanning a cell and comparing the result of the scanning with the stored cell environment information of the memory, and computing the number of cells within an acceptable error range and conducting a scanning at a predefined scanning period according to the number of cells.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the structure of a conventional UMA network;

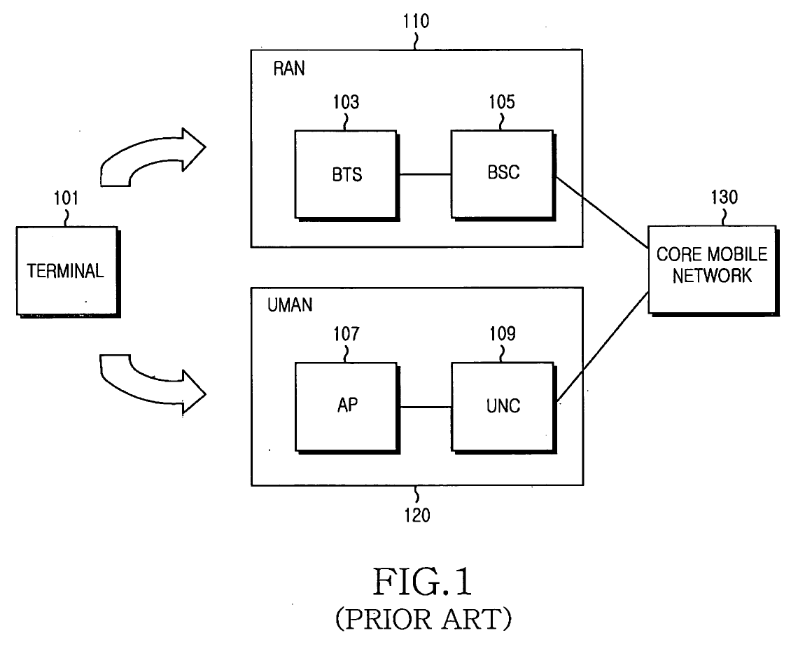

FIG. 2 is a block diagram of a portable communication terminal according to the present invention;

FIG. 3 illustrates a method for storing cell environment information of a portable communication terminal according to the present invention; and

FIG. 4 illustrates a method for scanning an AP of a portable communication terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

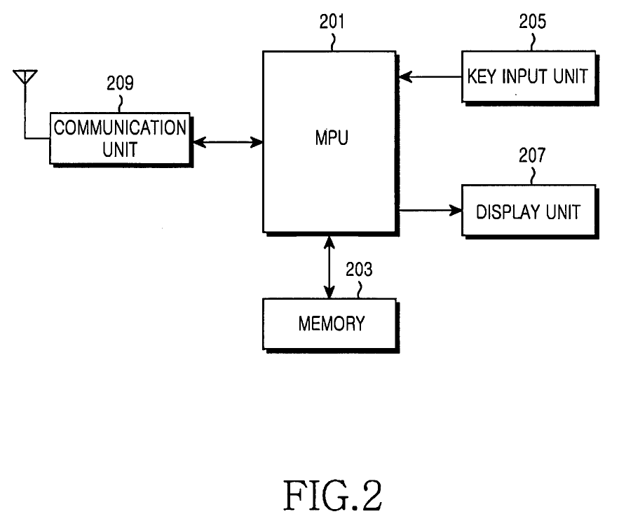

FIG. 2 is a block diagram of a portable communication terminal according to the present invention. The portable communication terminal includes a Micro-Processor Unit (MPU) 201, a memory 203, a key input unit 205, a display unit 207, and a communication unit 209.

Referring to FIG. 2, the MPU 201 controls the overall operation of the portable communication terminal. For example, the MPU 201 handles processing and controlling of voice and data communications, and according to an aspect of the present invention, additionally handles the storage of cell environment having a certain AP therein, as well as AP scanning based on a shortened scanning period if the environment is highly similar to the stored cell environment. The memory 203 includes a Read Only Memory (ROM), a Random Access Memory (RAM) and a Flash ROM. The ROM stores micro-codes of a program for processing and controlling, and a variety of other reference data. According to the present invention, a program may be stored, which causes a cell environment having a certain AP to be stored, and AP scanning to be performed according to a shortened scanning period if the environment is highly similar to the stored cell environment. The RAM may include a working memory of the MPU 201, and may store temporary data generated during the executing of the associated program. The Flash ROM stores various updatable data.

The key input unit 205 includes a plurality of function keys such as numeral keys 0˜9, menu button (MENU), cancel button (DELETE), confirm button, call button (TALK), end button (END), Internet access button and navigation keys or direction keys (▴/▾/ [symbol] / [symbol] ). The key input unit 205 provides the MPU 201 with key input data according to the keys pressed by the user. The display unit 207 displays status information generated during the operation of the portable communication terminal, a limited number of characters, and a large volume of moving or still images. The display unit 207 is implemented, for example, as a color Liquid Crystal Display (LCD).

The communication unit 209 processes transmission and reception of wireless signal that is input and output over the antenna. For example, in transmission, the communication unit 209 may conduct processing of data such as channel coding, spreading and Radio Frequency (RF), and transmit the data. In reception, the communication unit 209 may perform dispreading and channel decoding of the RF signal to recover the received data.

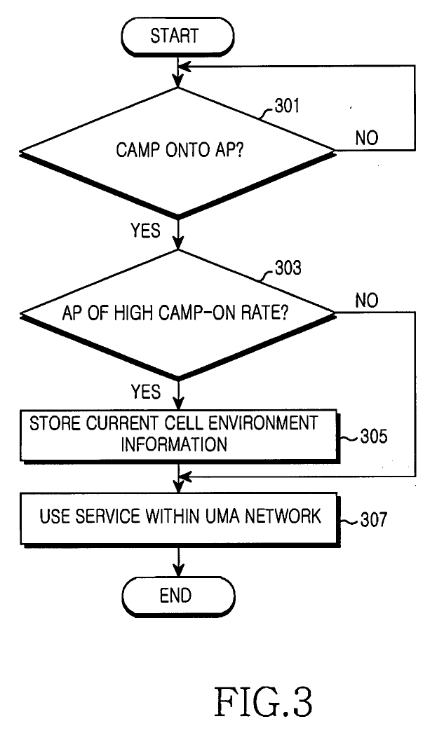

FIG. 3 illustrates a method of storing cell environment information of a portable communication terminal according to the present invention.

Referring to FIG. 3, a terminal determines whether or not it is camped onto a certain AP in step 301. Upon determination that the terminal is camped onto the certain AP in step 301, the terminal determines whether or not the camped AP has a high camp-on rate in step 303. The camp-on rate may be determined to be high or low, using a threshold.

Upon determination that the camped AP does not have a high camp-on rate, the terminal accesses a UNC through the AP and uses services within the UMA network in step 307.

Upon determination that the camped AP has the high camp-on rate, the terminal stores the current cell environment information to the memory 203 in step 305. According to the characteristics of a GSM cell, the terminal may constantly acquire information about the ambient cells through periodical scanning, and store the acquired information of the ambient cells to the memory 203.

The cell environment information is tabulated as below and stored.

TABLE 1

| Cell | Cell ID | ARFCN | Rx Level |
|---|---|---|---|
| Camped cell | | | |
| Near cell 1 | | | |
| Near cell 2 | | | |
| Near cell 3 | | | |
| Near cell 4 | | | |
| Near cell 5 | | | |
| Near cell 6 | | | |

Referring to Table 1, the cell environment information includes the cell IDentifiers (ID), the Absolute Radio Frequency Channel Number (ARFCN), which is the channel number to distinguish a designated RF channel of a GSM wireless system, and the reception (Rx) level of the camped cell and the near cells 1 to 6 (6 cells in case of GSM). The cell environment information may be stored in the order of Rx level.

Although the cell environment information is stored in this example to the memory 203 in the order of the camp-on rate of the AP, other examples are also possible. Particularly, the cell environment information of a cell may be stored, as the user selects a cell environment information store menu by a key manipulation.

The terminal accesses the UNC through the AP in step 307, and uses the services within the UMA network. The terminal then terminates the algorithm.

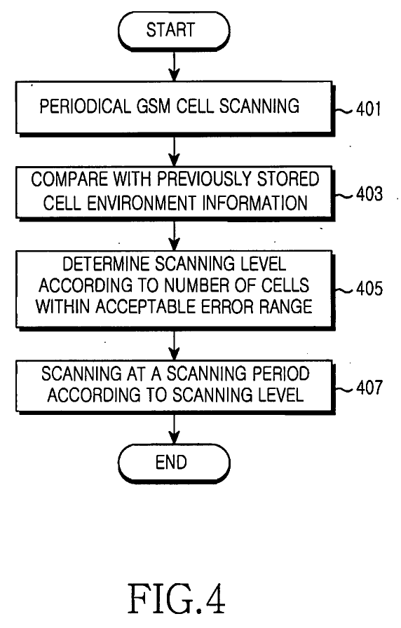

FIG. 4 illustrates a method of scanning an AP of a portable communication terminal according to the present invention.

Referring to FIG. 4, the terminal periodically scans GSM cells in step 401. The terminal compares the result of scanning in step 403 with the previously stored cell environment information of the certain AP, to determine whether or not the result of the scanning lies within an acceptable error range. The scanning result for comparison with the previously stored cell environment information may be limited to three or four cells of upper Rx levels, to increase accuracy.

For example, among the scanning result, the ID and the ARFCN of the camped cell and the four near cells 1, 2, 3 and 4 may be compared with those of the previously stored cell environment information, and if the compared information matches, the Rx levels of the cells may then be compared with each other. If it is assumed that the acceptable error range is 5 db, the Rx levels of the cells are compared with each other and it is determined whether or not the difference falls within the acceptable error range 5 db. If the scanning result virtually matches the previously stored cell environment information, the stored cell environment information may be updated based on the scanning result.

The terminal computes the number of cells within the acceptable error range, and determines the scanning level according to the obtained number of the cells in step 405.

The scanning level according to the number of the cells within the acceptable error range is tabulated as follows:

TABLE 2

| Number of cells | | |
|---|---|---|
| within range | Scanning level | Scanning period |
| 0 | 0 | 20 min |
| 1 | 1 | 15 min |
| 2 | 2 | 10 min |
| 3 | 3 | 8 min |
| 4 | 4 | 5 min |
| 5 | 5 | 3 min |
| 6 | 6 | 1 min |

Table 2 defines the scanning level according to the number of cells within the acceptable error range, and the scanning period according to the scanning level. Table 2 indicates that the scanning period is shorter, if there are more cells within the acceptable error range. In other words, the scanning period is shorter in the proximity of the AP such that the terminal can rapidly camp onto the AP.

The terminal conducts AP scanning, according to the scanning period, which is determined according to the scanning level in step 407. If there are three cells within the acceptable error range, based on Table 2, the scanning period is 8 min and therefore, the terminal conducts the AP scanning according to the period of 8 min. The terminal then terminates the algorithm.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

As explained above, according to the present invention, information about a cell environment including a certain AP therein is stored, and the AP scanning period is shortened if the environment has a high similarity to the stored cell environment. As a result, an active AP scanning, which considers the user environment, is provided, and power conservation and fast automatic rove-in/out and handover are also provided.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of scanning an Access Point (AP) of a portable communication terminal, comprising:
storing, upon camping onto an AP, current cell environment information to a memory;
periodically scanning a cell;
comparing a result of the scanning with the stored cell environment information of the memory; and
computing a total number of cells within an acceptable error range, and conducting a scanning at a scanning period according to the number of cells.

2. The method of claim 1, wherein the storing of the current cell environment information further includes:
determining, upon camping onto the AP, whether the AP has a high camp-on rate; and
storing, upon determining that the AP has the high camp-on rate, the current cell environment information to the memory.

3. The method of claim 1, wherein the storing of the current cell environment information further includes storing cell environment information of a cell, if a menu to store the cell environment information is selected.

4. The method of claim 1, wherein the scanning period is shorter, if there are more cells within the acceptable error range.

5. The method of claim 1, wherein the cell environment information includes at least one of a cell IDentifier (ID), an Absolute Radio Frequency Channel Number, which is the channel identification number, and a reception (Rx) level of a camped cell and a near cell.

6. An apparatus of scanning an Access Point (AP) of a portable communication terminal, comprising:
a memory for storing current cell environment information; and
a controller for storing, upon camping onto an AP, the current cell environment information to the memory, and periodically scanning a cell, and comparing a result of the scanning with the stored cell environment information of the memory; and computing a total number of cells within an acceptable error range and conducting a scanning at a predefined scanning period according to the number of cells.

7. The apparatus of claim 6, wherein the controller, in the step of storing the current cell environment information to the memory, determines, upon camping onto the AP, whether the AP has a high camp-on rate, and stores, upon determining that the AP has the high camp-on rate, the current cell environment information to the memory.

8. The apparatus of claim 6, wherein the controller, in the step of storing the current cell environment information to the memory, stores cell environment information of a cell, if a menu to store the cell environment information is selected.

9. The apparatus of claim 6, wherein the scanning period is shorter, if there are more cells within the acceptable error range.

10. The apparatus of claim 6, wherein the cell environment information includes at least one of a cell IDentifier (ID), an Absolute Radio Frequency Channel Number, which is the channel identification number, and a reception (Rx) level of a camped cell and a near cell.

11. A computer-readable recording medium having recorded thereon a program for scanning an Access Point (AP) in a mobile communication terminal, comprising:
a first code segment, for storing, upon camping onto an AP, current cell environment information to a memory;
a second code segment, for periodically scanning a cell;
a third code segment, for comparing a result of the scanning with the stored cell environment information of the memory; and
a fourth code segment, for computing a total number of cells within an acceptable error range, and conducting a scanning at a scanning period according to the number of cells.
